(19) United States
(12) Patent Application Publication
(10) Pub. No.: US 2025/0099926 A1
(43) Pub. Date: Mar. 27, 2025

(54) INGREDIENT BATCHING FOR LOW-ACID BEVERAGES

(71) Applicant: NIAGARA BOTTLING, LLC, Diamond Bar, CA (US)

(72) Inventors: Abhishek Shukla, Chino Hills, CA (US); Steven Kuo-Chuan Chen, Fountain Valley, CA (US)

(21) Appl. No.: 18/895,091

(22) Filed: Sep. 24, 2024

Related U.S. Application Data
(60) Provisional application No. 63/585,001, filed on Sep. 25, 2023.

(51) Int. Cl. B01F 23/50; A23J 3/00; A23L 2/66; B01F 23/80; B01F 35/11; B01F 35/92; B01F 101/14; B67D 1/00; B67D 1/08

(52) U.S. Cl. CPC B01F 23/59; A23J 3/00; A23L 2/66; B01F 23/511; B01F 23/811; B01F 35/11; B01F 35/92; B67D 1/0016; B67D 1/0884; B01F 2101/14

(57) ABSTRACT

A protein system may include a mixer configured to combine a powdered protein mix with water to produce a liquid protein blend. A protein system may include a liquid protein batch tank fluidly coupled to the mixer and configured to receive the liquid protein blend from the mixer. A protein system may include a holding subsystem including a liquid protein holding tank fluidly coupled to the liquid protein batch tank and configured to store the liquid protein blend received from the liquid protein batch tank, wherein the liquid protein holding tank is configured to maintain a temperature of the liquid protein blend contained therein less than or equal to 40 degrees Fahrenheit.

### CROSS-REFERENCE

This application claims priority to U.S. Provisional Patent Application No. 63/585,001, filed Sep. 25, 2023, the entire contents of which is hereby incorporated by reference.

### FIELD

The present disclosure relates to consumable liquid products, and more particularly to ingredient preparation for a low-acid beverage.

### BACKGROUND

Ingredients for consumable bottled liquid products are typically manually combined prior to introduction into a bottling line. The ingredients are combined according to a batching process to create a batch of the liquid product. The batch can be tested for quality and tracked by the bottler to ensure the proper combination of ingredients. When the liquid product is a low-acid beverage, the batching process may include a source of proteins such as milk concentrate/isolates or comparable plant-based sources that are dissolved in water to form a portion of the batch. The typical manual process is limited by time constraints making it difficult to create larger batches.

Low-acid liquid products, particularly those containing significant quantities of protein, may be dispensed into individual bottles by a bottling line. For example, chocolate milk is a low-acid liquid product including a milk base and chocolate flavoring. The low-acid liquid product is typically produced as a batch, i.e., a large, fixed quantity, by combining fixed quantities of multiple ingredients according to a recipe. The batch is then dispensed into individual bottles. The batch can be tested and monitored to assess the quality of the liquid product. Typically, the protein ingredient begins as a powder that is manually mixed with water when the batch is created. Once the protein ingredient is mixed with water, food safety regulations constrain the length of time during which the protein and water mixture can be held at certain temperatures without refrigeration or sterilization methods such as pasteurization.

### SUMMARY

The present disclosure provides, in one aspect, a protein system for a beverage batching system, the protein system including: a hydrating subsystem including: a mixer configured to combine a powdered protein mix with water to produce a liquid protein blend, and a liquid protein batch tank fluidly coupled to the mixer and configured to receive the liquid protein blend from the mixer; and a holding subsystem including a liquid protein holding tank fluidly coupled to the liquid protein batch tank and configured to store the liquid protein blend received from the liquid protein batch tank; wherein the liquid protein holding tank is configured to maintain a temperature of the liquid protein blend contained therein less than or equal to 40 degrees Fahrenheit.

The present disclosure provides, in another aspect, a beverage batching system including: a product batch tank; a non-protein system fluidly coupled to the product batch tank and configured to supply a non-protein ingredient to the product batch tank; a protein system fluidly coupled to the product batch tank and configured to supply a liquid protein blend to the product batch tank, the protein system including: a hydrating subsystem having a mixer configured to combine a powdered protein mix with water to produce the liquid protein blend, and a holding subsystem fluidly coupled to the hydrating subsystem and located downstream from the hydrating subsystem, the holding subsystem having a pasteurizer and a liquid protein holding tank.

The present disclosure provides, in another aspect, a method of batching a low-acid beverage, the method including: supplying a non-protein ingredient from a non-protein system to a product batch tank; combining a powdered protein mix with water in a mixer of a protein system to produce a liquid protein blend; storing the liquid protein blend in a liquid protein storage tank of the protein system; supplying the liquid protein blend from the liquid protein storage tank to the product batch tank; and combining the non-protein ingredient with the liquid protein blend within the product batch tank.

Other features and aspects of the disclosure will become apparent by consideration of the following detailed description and accompanying drawings.

### BRIEF DESCRIPTION OF THE DRAWINGS

FIG. 1 is a schematic illustrating an ingredient preparation and batching system according to one embodiment of the present disclosure.

FIG. 2 is a schematic illustrating a portion of the ingredient preparation and batching system of FIG. 1 in further detail.

FIG. 3 is a flow chart illustrating a method of batching a low-acid beverage.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

The present disclosure improves upon the batching process for low-acid liquid products by hydrating a powdered protein mix to create a hydrated liquid protein blend and holding the liquid protein blend separately from the other ingredients in the batch. The liquid protein blend may also be held above or below threshold temperatures to increase the allowable storage time under food safety regulations.

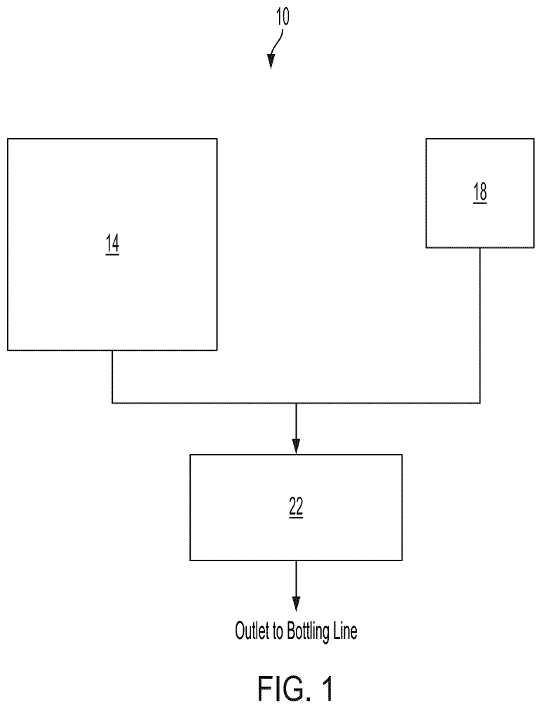

FIG. 1 is a schematic illustrating an ingredient preparation system 10 for a low-acid beverage. The ingredient preparation system 10 receives raw ingredients, such as a powdered protein mix, water, sugars, thickeners, flavors, or other additives, and combines the raw ingredients to form a batch of the low-acid beverage. The ingredient preparation system 10 includes a protein system 14 and a non-protein system 18. Ingredients from the protein system 14 and the non-protein system 18 are combined within one or more product batch tanks 22 to form the batch. For example, the non-protein system 18 may provide one or more non-protein ingredients, such as sugars, thickeners, preservatives, and/or other ingredients in dry or hydrated forms, to the product batch tank 22 for the batch. In some embodiments, the non-protein system 18 may utilize traditional, manual batching techniques. In other embodiments, the non-protein system 18 may be automated similarly to the protein system 14.

The ingredient preparation system 10 decouples preparation of ingredients in the protein and non-protein systems 14, 18. Decoupling preparation of the ingredients allows for larger batches to be created in less time while maintaining temperature sensitive ingredients (e.g., protein ingredients dissolved or mixed in water, such as milk) within a desired temperature range. In the illustrated embodiment, the protein system 14 receives a powdered protein mix, such as a powdered milk concentrate or milk protein isolates, and/or powdered plant-based protein mixes, and hydrates or adds water to the powdered protein mix to form a liquid protein blend. In some embodiments, one or more protein stabilizers can also be combined into the liquid protein blend. The illustrated protein system 14 then stores the liquid protein blend in a way that prevents spoiling. The protein system 14 of the ingredient preparation system 10 prepares a relatively large amount of liquid protein blend, i.e., an amount in excess of the amount necessary to form a batch, so that creation of new batches of the low-acid liquid product is not slowed by creation of the liquid protein blend.

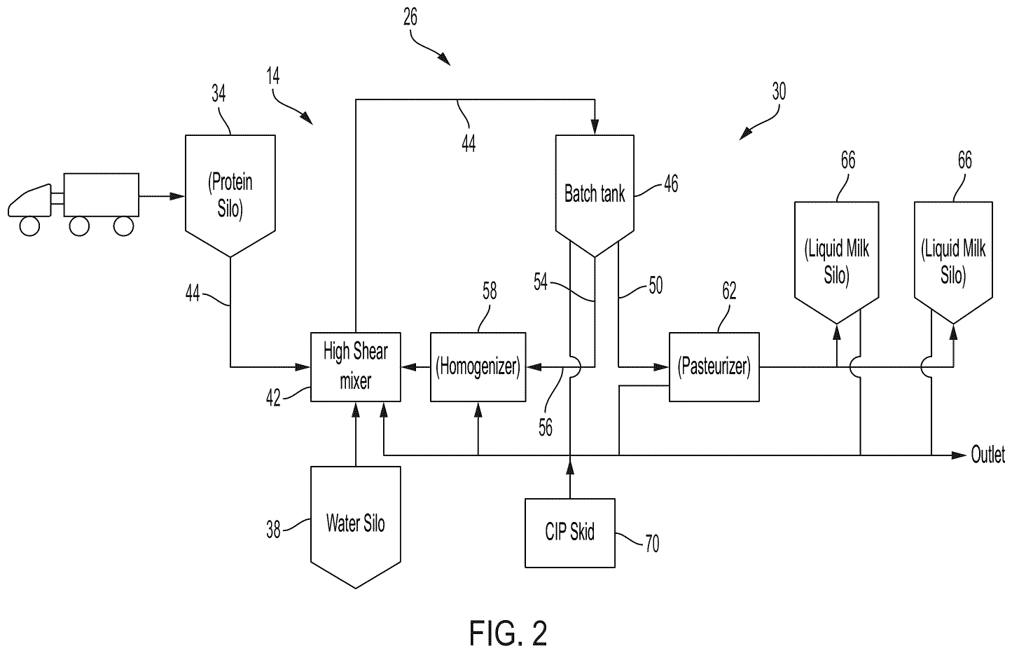

With reference to FIG. 2, the protein system 14 of the ingredient preparation system 10 includes a hydrating subsystem 26 and a holding subsystem 30. The hydrating subsystem 26 includes a series of stations that combine the powdered protein mix with water to form the liquid protein blend. The holding subsystem 30 prepares the liquid protein blend for temporary storage and temporarily stores the liquid protein blend prior to being combined with ingredients from the non-protein system 18 to form the batch of the low-acid liquid product.

With continued reference to FIG. 2, the hydrating subsystem 26 includes a powder silo 34 that receives and stores a powdered protein mix prior to use. The powder silo 34 is sized to store an amount of powdered protein mix greater than an amount required to form a single batch of the low-acid liquid product. In some embodiments, the powder silo 34 can be a first powder silo 34 and the hydrating subsystem 26 can include a second powder silo (not shown), or additional (i.e., third, fourth, etc.) powder silos. Each of the powder silos in these embodiments can store the same powdered protein mix or different powdered protein mixes (e.g., a first powdered protein mix comprising, e.g., a protein-containing milk concentrate and a second powdered protein mix comprising, e.g., a plant-based protein-containing mix). In the illustrated embodiment, the hydrating subsystem 26 also includes a water silo 38 that functions as a water input for the subsystem 26. The hydrating subsystem 26 further includes a mixer 42, such as a high shear mixer, which is operably coupled to both the powder silo 34 and the water silo 38. The hydrating subsystem 26 also includes a plurality of pipes 44 that fluidly couple the components of the subsystem 26 to one another and allow ingredients to move throughout the subsystem 26. In other embodiments (not shown), the hydrated subsystem 26 can also include one or more relatively smaller silos or hoppers containing other minor ingredients or additives in dry powder form (e.g., protein stabilizers, etc.) which can be operatively connected to the high shear mixer 42.

The high shear mixer 42 receives the powdered protein mix from the powder silo 34 and receives water from the water silo 38 to be combined into a liquid protein blend. The liquid protein blend may have a water to protein ratio consistent with a ratio of the final low-acid liquid product. In some embodiments, the liquid protein blend may have a higher concentration of protein than the final product and be combined with more liquid at a later step during the ingredient preparation process, such as during the final batching process. The temperature of the liquid protein blend initially produced in the high shear mixer 42 can be controlled. For example, the liquid protein blend produced in the high shear mixer 42 can be maintained below 40 degrees Fahrenheit in some examples, or above 150 degrees Fahrenheit in other examples.

The hydrating subsystem 26 further includes a liquid protein batch tank 46 disposed downstream of the high shear mixer 42. In some embodiments (not shown), the hydrating subsystem 26 can include more than one liquid protein batch tank 46 (e.g., two, three, or more than three liquid protein batch tanks). The liquid protein batch tank 46 receives the liquid protein blend from the high shear mixer 42 and temporarily stores the liquid protein blend prior to introduction into the holding subsystem 30. The liquid protein batch tank 46 has a first outlet 50 that directs the liquid protein blend to the holding subsystem 30. The liquid protein batch tank 46 also has a second outlet 54 connected to a recirculation line 56 that directs the liquid protein blend to recirculate back to the high shear mixer 42 within the hydrating subsystem 26. In the illustrated embodiment, the recirculation line 56 of the liquid protein batch tank 46 is operably coupled to a homogenizer 58 which, in turn, is operably coupled to the high shear mixer 42. In some embodiments, the hydrating subsystem 26 may not include a homogenizer between the liquid protein batch tank 46 and the high shear mixer 42. In yet other embodiments, the hydrating subsystem 26 may be able to selectively bypass the homogenizer 58 to route the liquid protein blend from the liquid protein batch tank 46 directly to the high shear mixer 42. Thus, the liquid protein blend may re-circulate within the hydrating subsystem 26 to continuously be combined with the powdered protein mix and water until a desired composition is attained and the liquid protein blend is directed from the liquid protein batch tank 46 to the holding subsystem 30.

With continued reference to FIG. 2, the holding subsystem 30 is disposed downstream of the hydrating subsystem 26 and operable to safely store liquid protein blends created by the hydrating subsystem 26 prior to use. In particular, the holding subsystem 30 is fluidly coupled to the first outlet 50 of the liquid protein batch tank 46. The holding subsystem 30 includes a pasteurizer 62 and at least one liquid protein holding tank 66. The pasteurizer 62 receives the liquid protein blend from the hydrating subsystem 26 and pasteurizes the liquid protein blend. The pasteurizer 62 then outputs the pasteurized liquid protein blend to be received in the liquid protein holding tank 66. In the illustrated embodiment, the holding subsystem 30 includes two liquid protein holding tanks 66 in fluid communication with the pasteurizer 62. Each of the liquid protein holding tanks 66 is temperature controlled to maintain the liquid protein blend contained therein at a temperature below 38 degrees Fahrenheit. The low storage temperature in combination with the pasteurization step allows the liquid protein blend to be stored in the liquid protein holding tank 66 for up to 72 hours. The liquid protein holding tank 66 is operably coupled to the product batch tank 22 (FIG. 1). In some embodiments, the liquid protein holding tanks 66 can be jacketed tanks to permit cooling (e.g., via chilled water, glycol, refrigerant, etc.) or heating (e.g., via steam) of the liquid protein blend therein.

With continued reference to FIG. 2, the protein system 14 of the ingredient preparation system 10 further includes a cleaning subsystem 70 in fluid communication with the hydrating and holding subsystems 26, 30. In the illustrated embodiment, the cleaning subsystem 70 is in fluid communication with the liquid protein batch tank 46. The cleaning subsystem 70 pumps a cleaning liquid through the hydrating and holding subsystems 26, 30 to clean and disinfect the components of the subsystems. The design and operation of the protein system 14 enables less frequent cleaning compared to typical ingredient preparation systems for low acid beverages. As discussed above, because the protein blend is pasteurized via the pasteurizer 62 prior to storage of the liquid protein blend in the liquid protein holding tank 66, and then stored below 38 degrees Fahrenheit, storage time is increased and can occur for up to 72 hours. The greater storage time enables less frequent cleaning. This is further made possible thanks to the protein system 14 handling only one type of liquid protein blend. Other prior art systems typically process multiple different blends and thus require the system to be cleaned whenever a new blend is introduced to prevent contamination. Thus, efficiency of the ingredient preparation system 10 is increased by decreasing downtime for activities such as cleaning.

To create a batch of a low-acid liquid product, liquid protein blend from the protein system 14 is combined with ingredients from the non-protein system 18. In particular, the liquid protein blend is pumped from the liquid protein holding tank 66 to the one or more product batch tanks 22 where it combines with the ingredients from the non-protein system 18. The liquid protein blend and the ingredients from the non-protein system 18 are mixed in the product batch tank 22 based on a recipe of the low-acid liquid product to create the batch. The completed batch is then transported to a bottling line where it is dispensed into individual bottles.

Independently of the low-acid liquid product batching process, the protein system 14 continually combines the powdered protein mix with water to form the liquid protein blend and stores the liquid protein blend in the liquid protein holding tanks 66. The protein system 14 can prepare and store quantities of the liquid protein blend in excess of a quantity required to form a single batch of the low-acid liquid product. Therefore, the protein system 14 allows for on-demand supply of the liquid protein blend to continuously meet the requirements of the low-acid liquid product batching process. The protein system can also be fluidly coupled to other liquid product batching systems and can supply liquid protein blend to multiple liquid product batching systems simultaneously. The on-demand supply of the liquid protein blend decreases the amount of time necessary to create a batch by having already hydrated the protein. The on-demand supply of the liquid protein may also allow for increasing a size of the batch, because creation of the batch is not time-limited by hydrating the protein. Moreover, one of the liquid protein holding tanks 66 can be used to receive freshly hydrated liquid protein blend while the other of the liquid protein holding tanks 66 can supply a prepared and stored liquid protein blend for a liquid product batch. Thus, the use of two liquid protein holding tanks 66 increases the efficiency of the protein system 14 as compared to traditional system or a system with a single liquid protein holding tank. In some embodiments, the liquid protein holding tanks 66 can have a holding capacity from 20,000 gallons to 100,000 gallons or more.

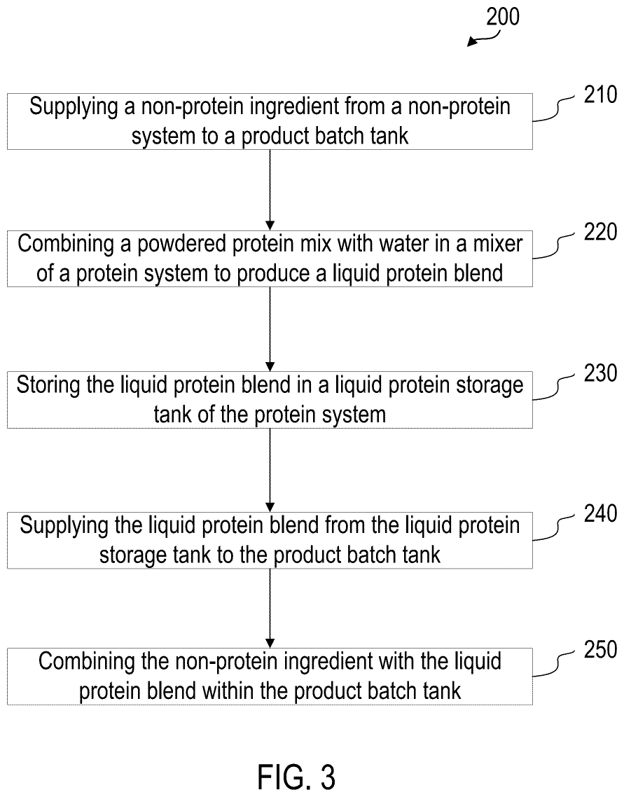

FIG. 3 illustrates a method 200 of preparing a low-acid beverage. At step 210, the method 200 includes supplying a non-protein ingredient from a non-protein system to a product batch tank. At step 220, the method 200 includes combining a powdered protein mix with water in a mixer of a protein system to produce a liquid protein blend. At step 230, the method 200 includes storing the liquid protein blend in a liquid protein storage tank of the protein system. Optionally, step 230 also includes pasteurizing the liquid protein blend produced by the mixer, such that the liquid protein blend is stored in the liquid protein storage tank in a pasteurized state. Optionally, step 230 also includes maintaining a temperature of the liquid protein blend stored within the liquid protein storage tank at less than or equal to 40 degrees. Fahrenheit At step 240, the method 200 includes supplying the liquid protein blend from the liquid protein storage tank to the product batch tank. At step 250, the method 200 includes combining the non-protein ingredient with the liquid protein blend within the product batch tank.

Although the disclosure has been described in detail with reference to preferred implementations, variations and modifications exist within the scope and spirit of one or more independent aspects of the disclosure as described. More particularly, one of ordinary skill in the art will understand the scalability of the above-described ingredient preparation and batching system. The system is scalable to accommodate any number of desired production lines.

What is claimed is:

1. A protein system for a beverage batching system, the protein system comprising:
a hydrating subsystem including:
a mixer configured to combine a powdered protein mix with water to produce a liquid protein blend, and
a liquid protein batch tank fluidly coupled to the mixer and configured to receive the liquid protein blend from the mixer; and
a holding subsystem including a liquid protein holding tank fluidly coupled to the liquid protein batch tank and configured to store the liquid protein blend received from the liquid protein batch tank;
wherein the liquid protein holding tank is configured to maintain a temperature of the liquid protein blend contained therein less than or equal to 40 degrees Fahrenheit.

2. The protein system of claim 1, wherein the holding subsystem further includes a pasteurizer fluidly coupled to an outlet of the liquid protein batch tank and to an inlet of the liquid protein holding tank.

3. The protein system of claim 1, wherein the hydrating subsystem further includes a homogenizer fluidly coupled to an outlet of the liquid protein batch tank and to an inlet of the mixer.

4. The protein system of claim 1, wherein the hydrating subsystem further includes a powder silo configured to store the powdered protein mix, and wherein the mixer is fluidly coupled to powder silo and is configured to receive the powdered protein mix from the powder silo.

5. The protein system of claim 1, further comprising a cleaning subsystem fluidly coupled to the hydrating subsystem and the holding subsystem and configured to pump a cleaning fluid through the hydrating subsystem and the holding subsystem.

6. The protein system of claim 1, wherein the liquid protein holding tank is a first liquid protein holding tank and the holding subsystem further includes a second liquid protein holding tank fluidly coupled to the liquid protein batch tank.

7. The protein system of claim 1, wherein the hydrating subsystem further includes:
a homogenizer fluidly coupled to a first outlet of the liquid protein batch tank and to an inlet of the mixer; and
a powder silo configured to store the powdered protein mix, and wherein the mixer is fluidly coupled to powder silo and is configured to receive the powdered protein mix from the powder silo.

8. The protein system of claim 7, wherein the holding subsystem further includes a pasteurizer fluidly coupled to a second outlet of the liquid protein batch tank and to an inlet of the liquid protein holding tank.

9. A beverage batching system comprising:
a product batch tank;
a non-protein system fluidly coupled to the product batch tank and configured to supply a non-protein ingredient to the product batch tank;
a protein system fluidly coupled to the product batch tank and configured to supply a liquid protein blend to the product batch tank, the protein system including:
a hydrating subsystem having a mixer configured to combine a powdered protein mix with water to produce the liquid protein blend, and
a holding subsystem fluidly coupled to the hydrating subsystem and located downstream from the hydrating subsystem, the holding subsystem having a pasteurizer and a liquid protein holding tank.

10. The beverage batching system of claim 9, wherein the liquid protein holding tank is configured to store the liquid protein blend contained therein at a temperature less than or equal to 40 degrees Fahrenheit.

11. The beverage batching system of claim 9, wherein the pasteurizer is configured to pasteurize the liquid protein blend produced by the mixer and supply the liquid protein blend to the liquid protein holding tank in a pasteurized state.

12. The beverage batching system of claim 9, wherein the hydrating subsystem further includes a liquid protein batch tank fluidly coupled to the mixer and configured to receive the liquid protein blend from the mixer.

13. The beverage batching system of claim 12, wherein the hydrating subsystem further includes a recirculation line configured to recirculate the liquid protein blend from the liquid protein batch tank back to the mixer.

14. The beverage batching system of claim 13, wherein a first outlet of the liquid protein batch tank is fluidly coupled to the pasteurizer and a second outlet of the liquid protein batch tank is fluidly coupled to the recirculation line.

15. The beverage batching system of claim 13, wherein the recirculation line includes a homogenizer configured to homogenize the liquid protein blend recirculating back to the mixer.

16. The beverage batching system of claim 9, wherein the hydrating subsystem further includes a powder silo configured to store the powdered protein mix, and wherein the mixer is fluidly coupled to powder silo and is configured to receive the powdered protein mix from the powder silo.

17. The beverage batching system of claim 9, wherein the liquid protein holding tank is a first liquid protein holding tank and the holding subsystem further includes a second liquid protein holding tank fluidly coupled to the hydrating subsystem.

18. A method of batching a low-acid beverage, the method comprising:
supplying a non-protein ingredient from a non-protein system to a product batch tank;
combining a powdered protein mix with water in a mixer of a protein system to produce a liquid protein blend;
storing the liquid protein blend in a liquid protein storage tank of the protein system;
supplying the liquid protein blend from the liquid protein storage tank to the product batch tank; and
combining the non-protein ingredient with the liquid protein blend within the product batch tank.

19. The method of claim 18, further comprising pasteurizing the liquid protein blend produced by the mixer, wherein the liquid protein blend is stored in the liquid protein storage tank in a pasteurized state.

20. The method of claim 18, further comprising maintaining a temperature of the liquid protein blend stored within the liquid protein storage tank at less than or equal to 40 degrees Fahrenheit.
